(19) United States
(12) Patent Application Publication
(10) Pub. No.: US 2006/0188770 A1
(43) Pub. Date: Aug. 24, 2006

(54) Compound flow field board for fuel cell

(76) Inventors: Hsi-Ming Shu, Taipei (TW); Feng-Yi Deng, Taipei (TW); Wei-Li Huang, Taipei (TW)

Correspondence Address: G. LINK CO., LTD, 3550 Bell Road, MINOOKA, IL, 60447, US

(21) Appl. No.: 11/359,595

(22) Filed: Feb. 23, 2006

(30) Foreign Application Priority Data
Feb. 24, 2005 (TW) 094202911

(51) Int. Cl. H01M 2/08; H01M 8/02

(52) U.S. Cl. 429/36; 429/38

(57) ABSTRACT

A compound flow field board for a fuel cell comprises at least a first region and a second region. The first region includes a substrate made of a heat-conductive material, and is disposed corresponding to a membrane electrode assembly. The first region also comprises a projection protruded into the second region. The second region includes a substrate made of an adhesive material, and is connected with the first regions such that the compound flow field board becomes a one-piece structure.

### FIELD OF THE INVENTION

The present invention relates to a structure of flow channels layer used in a fuel cell, and more particularly, to a flow field board of a fuel cell, which is made of composite material and can radiate heat. Thereby, heat within the fuel cell is conducted to the flow field board and radiated out.

### BACKGROUND OF THE INVENTION

Conventional flow field boards of fuel cells usually put more emphasis on the structure of flow channels to smoothly flow fuel into membrane electrode assemblies (MEAs) through the flow channels. In addition, the conventional flow field board is made from only one kind of substrate.

Therefore, an improved compound flow field board is provided to overcome the foresaid disadvantages, which could raise the radiating heat function.

### SUMMARY OF THE INVENTION

It is a primary object of the invention to provide a compound flow field board, which can radiate heat. Thereby, heat within the fuel cell is conducted to the compound flow field board and is radiated out.

In accordance with the object of the invention, an improved compound flow field board for a fuel cell is provided. The compound flow field board comprises at least a first region including a substrate made of a heat-conductive material, wherein the first region is disposed corresponding to a membrane electrode assembly, and a second region including a substrate made of an adhesive material, wherein the second region is connected with the first region such that the compound flow field board becomes a one-piece structure. Also, the first region comprises a projection protruded into the second region.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates the structure of a compound flow field board for a fuel cell according to one embodiment of the invention;

FIG. 2 shows the structure of a compound flow field board for a fuel cell according to a preferred embodiment of the invention;

FIG. 3 is a diagram showing that the protruded portions are connected with the radiation components according to one embodiment of the invention;

FIG. 4 shows the structure of a third substrate according to one embodiment of the invention; and

FIG. 5 is a diagram showing that the compound flow field board is connected to the third substrate according to one embodiment of the invention.

### DETAILED DESCRIPTION OF THE INVENTION

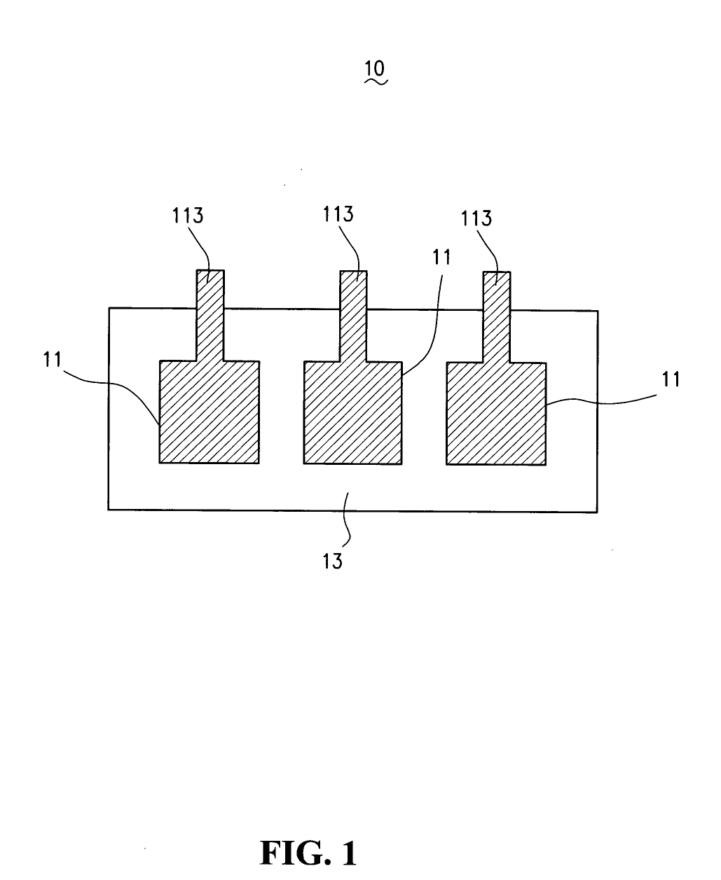

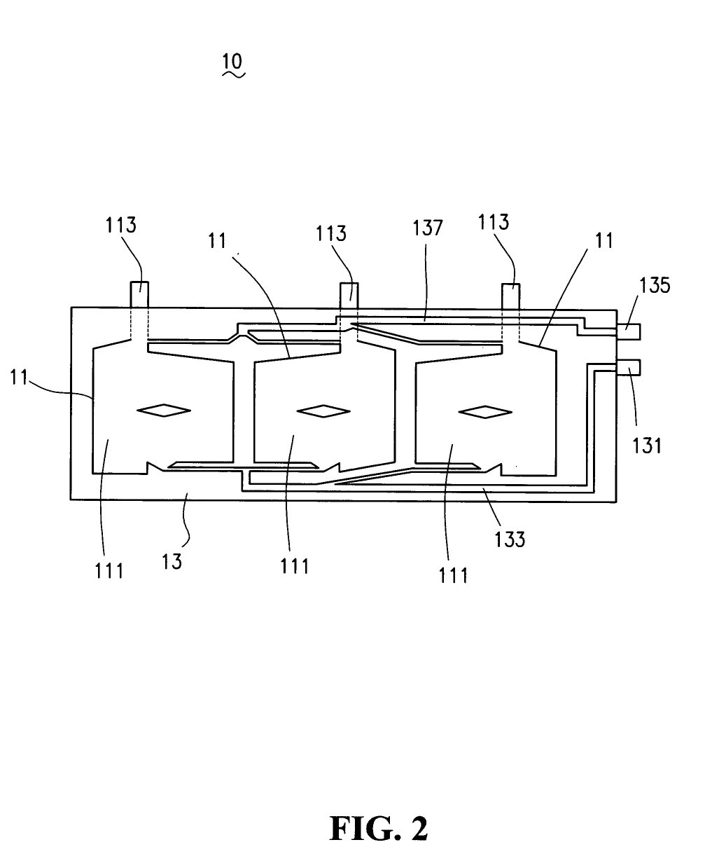

FIG. 1 illustrates the structure of a compound flow field board for a fuel cell according to one embodiment of the invention. FIG. 2 shows the structure of a compound flow field board for a fuel cell according to a preferred embodiment of the invention. The compound flow field board 10 includes at least a first region 11 and a second region 13, wherein the first regions 11 are connected to the second region 13. The resultant compound flow field board 10 is a one-piece structure. The first region 11 includes a substrate made of a heat-conductive material, for example, aluminum, copper, aluminum alloy, copper alloy, stainless steel foil, golden foil, single metal, or metal alloy. The second region 13 includes a substrate made of an adhesive material, for example, a plastic substrate, a ceramic substrate, a printed circuit substrate, or a polymer plastic substrate.

Each first region 11 of the compound flow field board 10 is positioned corresponding to a membrane electrode assembly (MEA) (not shown). The first region 11 includes at least a concave portion 111 disposed corresponding to the MEA. Accordingly, fuels within the concave portion 111, such as liquid fuel like methanol solution, gaseous fuel like hydrogen, anode fuel, and cathode fuel, flow into the MEA, initializing electrochemical reaction and generating heat. Because the first region 11 conducts heat well, the temperature of the fuel in the concave portion 111 can be distributed uniformly, and heat can be radiated out of the MEA.

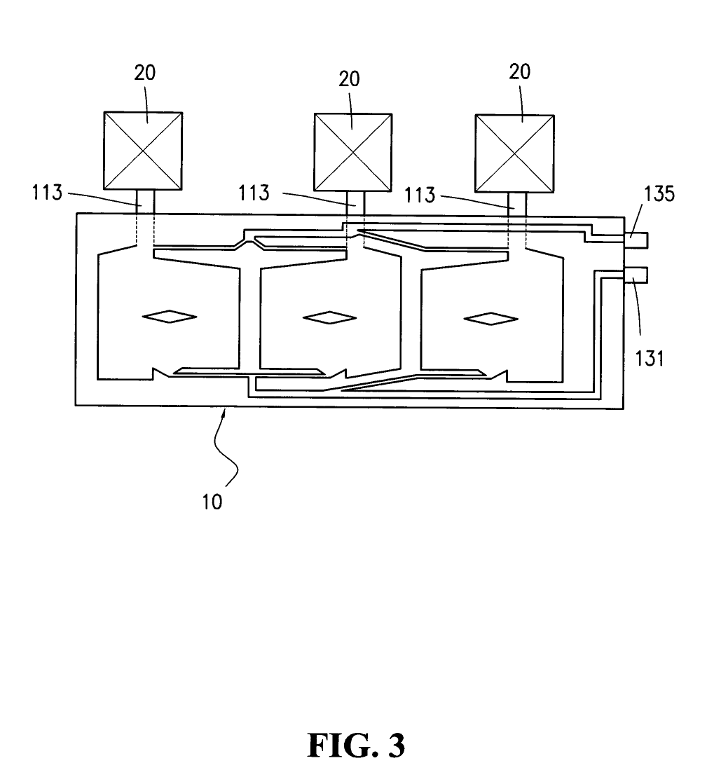

A projection 113 disposed on each first region 11 is protruded into the second region 13. Heat within the concave portion 111 is conducted to the projection 113, and hence heat produced by the MEA is radiated away from the compound flow field board 10 completely. Referring to FIG. 3, the projection 113 is exposed in the air, and connected to a radiation component 20, or is connected with a fuel tank of fuel cells. The radiation component 20 may be a metal lamina, a heat-conductive pipe, a heat- radiating flake, a heat sink, or a cooling device. The cooling device may be a fan or a cold water cooling device. The radiation component 20 is used to rapidly radiate heat over the projection 113.

With reference to FIG. 2, the second region 13 includes an inlet 131, an injection flow channel 133, an outlet 135, and an exhaust flow channel 137, which are separately described hereinafter. The inlet 131 is used to inject fuel like methanol solution, hydrogen, anode fuel, and cathode fuel. The inlet 131 is disposed on the side of the second region 13. The injection flow channel 133 is connected to the input of the concave portion 111 and the inlet 131. The exhaust flow channel 137 is connected to the output of the concave portion 111 and the outlet 135. The flow channels 133, 137 are, for example, a plurality of trenches formed on the surface of the second region 13.

External fuel injected from the inlet 131 flows into the injection flow channel 133, the concave portion 111 and the MEA sequentially. As a result, the MEA performs an electrochemical reaction to generate power. Fuel in the concave portion 111 and products generated during electrochemical reaction flow into the exhaust flow channel 137, and are drained out from the outlet 135.

The first region 11 may be made from an acid-resisting metal substrate or an anticorrosive metal substrate, such as gold (Au). Or, the surface of the first region 11 may be further treated by an acid-resisting process or an anticorrosive process to protect the first region 11 from being damaged by fuel or products of electrochemical reaction. The acid-resisting process is performed, for example, by coating Teflon onto the whole surface of the first region 11. The anticorrosive process is performed, for example, by covering a lamina of anticorrosive conductive material like Au onto the surface of the first region 11. Hence, the resultant compound flow field board 10 is acid-resisting or anticorrosive.

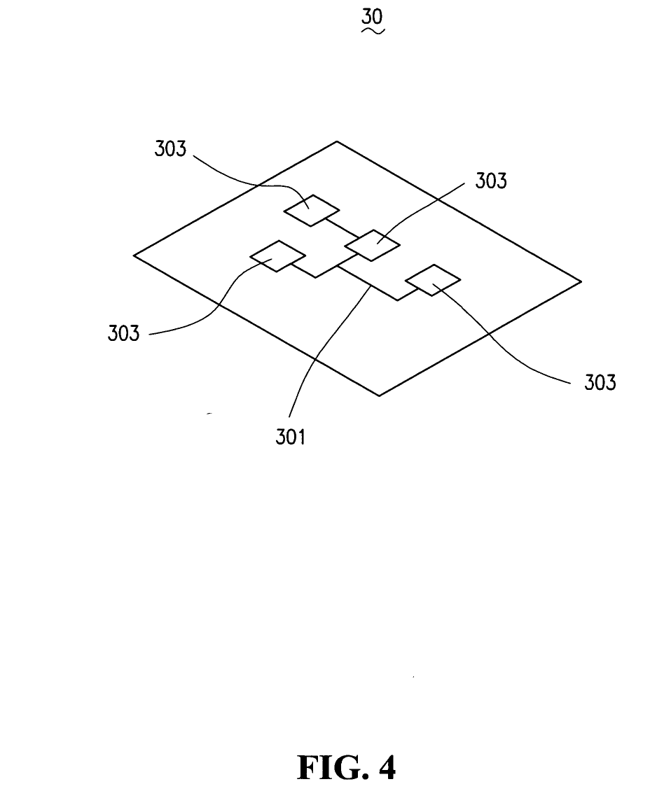

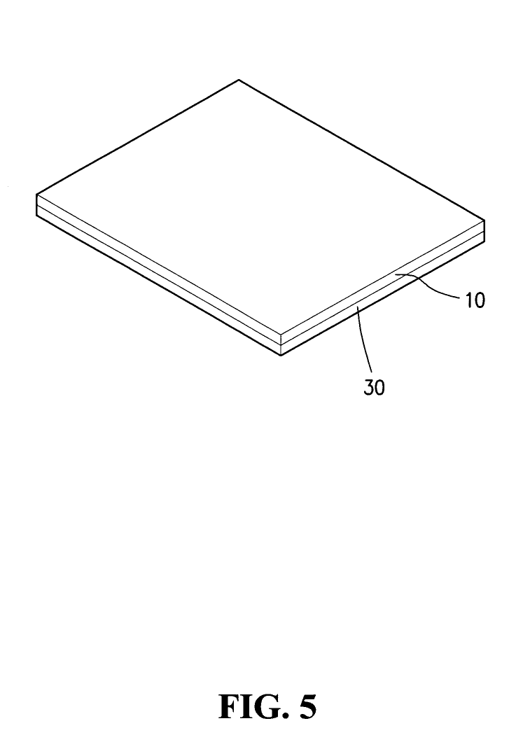

Since the second region 13 is made from a plastic substrate, a ceramic substrate, a printed circuit substrate, or a polymer plastic substrate, its surface may serve to deploy layouts of electrical circuits and to dispose a plurality of electrical devices thereon. Besides, another third substrate 30 can be used as well with reference to FIG. 4. The third substrate 30 is made of, for example, a printed circuit substrate. A layout 301 is formed on the surface of the third substrate 30, and plurality of electrical component 303 is soldered thereon. Such third substrate 30 with circuitry is connected to the compound flow field board 10, so as to form a one-piece structure as shown in FIG. 5. It is noted that the invention is not limited to stack the third substrate 30 and the compound flow field board 10 up and down. The third substrate 30 and the compound flow field board 10 can also be bound with front and back. Consequently, the compound flow field board 10 further comprises the function of electrical circuitry.

To sum up, the compound flow field board possesses the advantages as following:

1. It utilizes well heat-conductive material to uniformly distribute the temperature of anode fuel or cathode fuel, and radiates heat out by means of protruded portions and radiation components. Thereby, the efficiency of power generation in a fuel cell system is increased and the shelf life of MEA is extended;

2. Furthermore, it utilizes well adhesive material to connect the flow field board with the current collection layer in a sealed way. Therefore, the compound flow field board has utility; and

3. Moreover, it s feasible to form an intelligent flow field board by combining a printed circuit substrate with an circuit layout disposed thereon.

The preferred embodiment disclosed is only for illustrating the present invention, and not for giving any limitation to the scope of the present invention. It will be apparent to those skilled in this art that various modifications or changes can be made to the present invention without departing from the spirit and scope of this invention. Accordingly, all such modifications and changes also fall within the scope of protection of the appended claims.

What is claimed is:

1. A compound flow field board for a fuel cell, comprising:
at least a first region including a substrate made of a heat-conductive material, and is disposed corresponding to a membrane electrode assembly (MEA); and
a second region including a substrate made of an adhesive material, wherein the second region is connected with said first regions such that the compound flow field board becomes a one-piece structure;
wherein each said first region has a projection protruded into the second region.

2. The flow field board of claim 1, wherein the first region comprises a concave portion for containing a fuel.

3. The flow field board of claim 1, wherein the heat-conductive material is selected from a group consisting of aluminum, copper, aluminum alloy, copper alloy, stainless steel foil, golden foil, single metal, and metal alloy.

4. The flow field board of claim 1, wherein the second substrate material is a plastic substrate, a ceramic substrate, a printed circuit substrate, or a polymer plastic substrate.

5. The flow field board of claim 1, wherein the second region further comprises:
a fuel inlet disposed on a side of the second region; and
an injection flow channel disposed on the second region and connected to the fuel inlet.

6. The flow field board of claim 1, wherein the second region further comprises:
an outlet disposed on a side of the second region; and
an exhaust flow channel disposed on the second region and connected to the fuel outlet.

7. The flow field board of claim 2, wherein the fuel is a methanol solution.

8. The flow field board of claim 2, wherein the fuel is a liquid fuel.

9. The flow field board of claim 2, wherein the fuel is a gaseous fuel.

10. The flow field board of claim 2, wherein the fuel is an anode fuel.

11. The flow field board of claim 2, wherein the fuel is a cathode fuel.

12. The flow field board of claim 1, wherein a surface of the first region is treated by an acid-resisting process.

13. The flow field board of claim 1, wherein a surface of the first region is coated with Teflon.

14. The flow field board of claim 1, wherein the projection is exposed in air.

15. The flow field board of claim 1, wherein the projection is connected to a radiation component.

16. The flow field board of claim 1, wherein the projection is connected to a fuel tank.

17. The flow field board of claim 15, wherein the radiation component is a metal lamina, a heat-conductive tube, a heat-radiating flake, a heat sink, or a cooling device.

18. The flow field board of claim 1, wherein the compound flow field board is connected with a third substrate, so as to form a one-piece structure.

19. The flow field board of claim 1, further comprising a circuit layout disposed on a surface of the second region.
